(19) United States
(12) Patent Application Publication
(10) Pub. No.: US 2026/0280013 A1
(43) Pub. Date: Sep. 17, 2026

(54) CELL STACK SUPPORT ASSEMBLY HAVING ADHESIVE-RECEIVING APERTURES

(71) Applicant: Ford Global Technologies, LLC, Dearborn, MI (US)

(72) Inventors: Mihir Devendra Upadhye, Ann Arbor, MI (US); Jie Deng, Novi, MI (US); Brian Utley, Canton, MI (US); Liam E. West, Ferndale, MI (US); Pradeep Elumalai, Northville, MI (US)

(21) Appl. No.: 19/076,740

(22) Filed: Mar. 11, 2025

(51) Int. Cl. H01M 50/262; H01M 10/613; H01M 10/625; H01M 10/6567; H01M 50/211; H01M 50/249; H01M 50/271; H01M 50/291; H01M 50/293

(52) U.S. Cl. CPC H01M 50/262; H01M 10/613; H01M 10/625; H01M 10/6567; H01M 50/249; H01M 50/271; H01M 50/291; H01M 50/293; H01M 50/211

(57) ABSTRACT

A battery pack assembly includes an enclosure assembly and a support assembly of a cell stack. The support assembly has a peripheral portion that is at least partially received within a groove of the enclosure assembly. The peripheral portion has one or more apertures. An adhesive bonds the peripheral portion to the enclosure assembly. The adhesive extending through the one or more apertures.

### TECHNICAL FIELD

This disclosure details exemplary support assemblies used to support a cell stack within an enclosure assembly of a traction battery pack and, more particularly, to how the support assemblies are connected to the enclosure assembly.

### BACKGROUND

Electrified vehicles differ from conventional motor vehicles because electrified vehicles include a drivetrain having one or more electric machines. The electric machines can drive the electrified vehicles instead of, or in addition to, an internal combustion engine. A traction battery pack assembly can power the electric machines. As part of an immersion thermal management system, liquid coolant can be moved through the traction battery pack to help manage thermal energy within the traction battery pack.

### SUMMARY

In some aspects, the techniques described herein relate to a battery pack assembly, including: an enclosure assembly; a support assembly of a cell stack, the support assembly having a peripheral portion that is at least partially received within a groove of the enclosure assembly, the peripheral portion having one or more apertures; and an adhesive bonding the peripheral portion to the enclosure assembly, the adhesive extending through the one or more apertures.

In some aspects, the techniques described herein relate to a battery pack assembly, wherein the peripheral portion is a first peripheral portion of the support assembly on a first side of the cell stack, the support assembly further including a second peripheral portion on an opposite second side of the cell stack, wherein the groove is a first groove within an enclosure cover of the enclosure assembly, the second peripheral portion of the support assembly received within a second groove of the enclosure assembly, the second groove within an enclosure tray of the enclosure assembly.

In some aspects, the techniques described herein relate to a battery pack assembly, wherein the first peripheral portion extends vertically upward from the cell stack, and the second peripheral portion extends vertically downward from the cell stack.

In some aspects, the techniques described herein relate to a battery pack assembly, wherein the support assembly has a C-shaped cross-sectional profile.

In some aspects, the techniques described herein relate to a battery pack assembly, wherein the cell stack includes a plurality of battery cells disposed along an axis, the support assembly having a divider section that extends between battery, and a flange extending transversely from the divider section, wherein the flange and the at least one aperture are within the peripheral portion.

In some aspects, the techniques described herein relate to a battery pack assembly, wherein the one or more apertures each extend completely through the flange, from a first side of the flange to an opposite, second side of the flange.

In some aspects, the techniques described herein relate to a battery pack assembly, wherein the first side of the flange faces outward away from the cell stack, and the second side of the flange faces inward toward the cell stack.

In some aspects, the techniques described herein relate to a battery pack assembly, wherein the one or more apertures are one or more tapered bore.

In some aspects, the techniques described herein relate to a battery pack assembly, wherein the one or more apertures each extend along a respective aperture axis that is transverse to an axis of the cell stack.

In some aspects, the techniques described herein relate to a battery pack assembly, wherein the one or more apertures each extend along a respective aperture axis that is transverse to an axis of the cell stack.

In some aspects, the techniques described herein relate to a battery pack assembly, wherein the cell stack is at least partially immersed in a dielectric liquid coolant.

In some aspects, the techniques described herein relate to a battery pack assembly, wherein the support assembly supports the cell stack within the enclosure assembly at a position where battery cells of the cell stack are spaced from an enclosure tray of the enclosure assembly and are spaced from an enclosure cover of the enclosure assembly.

In some aspects, the techniques described herein relate to a battery pack assembly, wherein the support assembly is a metal or a metal alloy.

In some aspects, the techniques described herein relate to a battery pack assembly, wherein the one or more apertures are one or more open slots that each open to an endface of the peripheral portion.

In some aspects, the techniques described herein relate to a battery pack assembly, wherein the one or more apertures are one or more cylindrical bores.

In some aspects, the techniques described herein relate to a battery pack assembly, wherein the one or more apertures each extend completely through the support assembly.

In some aspects, the techniques described herein relate to a battery pack assembly, including: an enclosure assembly holding a dielectric immersion coolant; at least one first battery cell of a cell stack; at least one second battery cell of the cell stack; and a support assembly that supports the cell stack within an enclosure assembly, the support assembly disposed axially between the at least one first battery cell and the at least one second battery cell, the support assembly having a first peripheral portion bonded to a first groove of the enclosure assembly on a first side of the cell stack, and a second peripheral portion bonded to a second groove of the enclosure assembly on an opposite, second side of the cell stack, the first and second peripheral portions each having one or more apertures that hold an adhesive.

In some aspects, the techniques described herein relate to a battery pack assembly, further including an enclosure cover and an enclosure tray of the enclosure assembly, the enclosure cover providing the first groove, the enclosure tray providing the second groove.

In some aspects, the techniques described herein relate to a battery pack assembly, wherein the one or more apertures in the first peripheral portion includes one or more first open slots that each open to a first endface of the first peripheral portion, wherein the one or more apertures in the second peripheral portion include one or more second open slots that each open to a second endface of the second peripheral portion.

In some aspects, the techniques described herein relate to a battery pack assembly, wherein the one or more apertures each extend completely through the support assembly.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle having a battery pack.

FIG. 2 illustrates a perspective, schematic view of a battery array from the battery pack of FIG. 1.

FIG. 3 illustrates an expanded view of the battery array of FIG. 2.

FIG. 4 illustrates a section view of the battery array taken at line 4-4 in FIG. 2 and showing a portion of a cell stack disposed between an enclosure cover and an enclosure tray.

FIG. 5 illustrates a close-up view of an area of FIG. 4 showing a portion of a support assembly and portions of battery cells of the cell stack.

FIG. 6 illustrates a close-up view of an area of FIG. 4 showing a portion of a support assembly and portions of battery cells of the cell stack.

FIG. 7 illustrates a perspective view of a support fin from the support assembly of FIGS. and 6 according to an exemplary embodiment of the present disclosure.

FIG. 7A is a close-up view of an area of FIG. 7.

FIG. 8 illustrates a perspective view of a support fin according to another exemplary embodiment of the present disclosure.

FIG. 8A illustrates a close-up view of an area of FIG. 8.

FIG. 9 illustrates a perspective view of a support fin according to yet another exemplary embodiment of the present disclosure.

FIG. 9A illustrates a close-up view of an area of FIG. 9.

FIG. 10 illustrates a perspective view of a support fin according to yet another exemplary embodiment of the present disclosure.

FIG. 10A illustrates a close-up view of an area of FIG. 10.

FIG. 11 illustrates a perspective view of a support fin according to yet another exemplary embodiment of the present disclosure.

FIG. 11A illustrates a close-up view of an area of FIG. 11.

FIG. 11B illustrates a section view taken through a support assembly having the support fin of FIG. 11.

FIG. 12 illustrates a perspective view of a support fin according to yet another exemplary aspect of the present disclosure.

FIG. 12A illustrates a close-up view of an area of FIG. 12.

### DETAILED DESCRIPTION

An immersion thermal management system can be used to manage thermal energy in a traction battery pack. In such a traction battery pack, at least some components of the traction battery pack are immersed in a liquid coolant within an enclosure. The immersed components can include a cell stack.

This disclosure is directed toward a support assembly utilized to support a cell stack of a traction battery pack. The battery pack can be an immersion-cooled battery pack as described above. In particular, the support assembly can include a support fin having at least one aperture. Adhesive can move into the at least one aperture to facilitate adhesively bonding the support assembly to the enclosure.

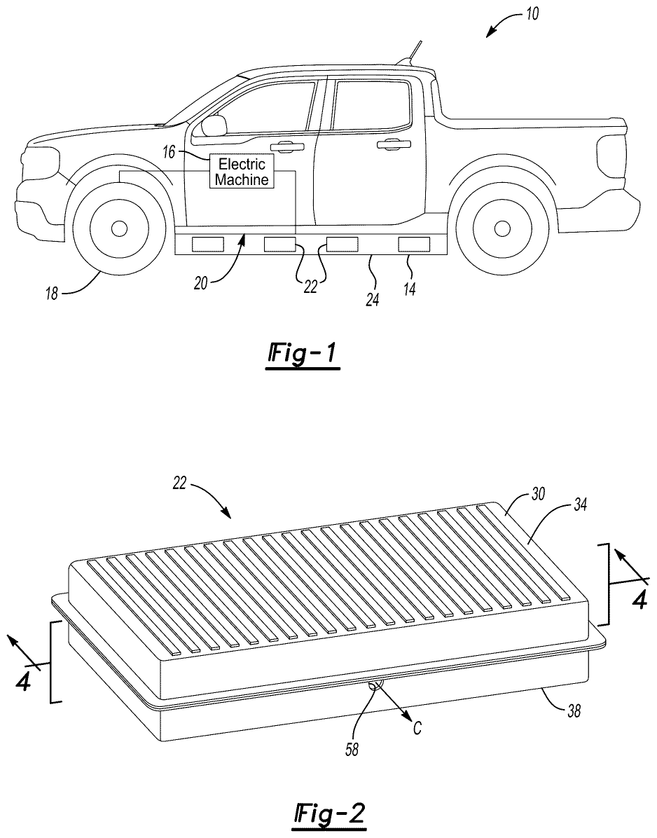

With reference to FIG. 1, an electrified vehicle 10 includes a traction battery pack 14, an electric machine 16, and wheels 18. The traction battery pack 14 powers the electric machine 16, which can convert electrical power to mechanical power to drive the wheels 18. The traction battery pack 14 can be a relatively high-voltage battery.

The traction battery pack 14 is, in the exemplary embodiment, secured to an underbody 20 of the electrified vehicle 10. The traction battery pack 14 could be located elsewhere on the electrified vehicle 10 in other examples. In the exemplary embodiment, the traction battery pack 14 includes one or more battery arrays 22 housed within a pack enclosure 24.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a traction battery pack.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

FIGS. 2-4 illustrate additional detail of one of the arrays 22 from the battery pack 14. In this example, the array 22 includes an array enclosure assembly 30 having enclosure structures —here a cover 34 and a tray 38. The cover 34, in this example, is vertically above the tray 38. In other examples, however, the cover 34 could be arranged below, or to a side of the tray 38.

Various terms such as “vertical,” “above,” “below,” “top,” and “bottom” are used relative to the arrangement of the components of the battery array 22 in the various drawings and should not otherwise be deemed limiting. These terms are with reference to the general orientation of the battery array 22 when installed within the vehicle 10 of FIG. 1,

The cover 34 is welded to the tray 38 in one example of this disclosure. While welding is mentioned, the cover 34 and tray 38 could be connected using other fluid-tight connection techniques, such as adhesive. Further, while an exemplary enclosure assembly 30 is shown in the drawings, the enclosure assembly 30 may vary in size, shape, and configuration within the scope of this disclosure.

In this disclosure, a cell stack 42 is arranged within an interior of the enclosure assembly 30. The example cell stack 42 includes a plurality of individual battery cells 46 disposed along a cell stack axis A, and a plurality of support assemblies 50. In this example, each of the support assemblies 50 is sandwiched between two of the battery cells 46 along the cell stack axis A. The battery cells 46 and support assemblies 50 can be compressed along the cell stack axis A between a pair of endplates 52.

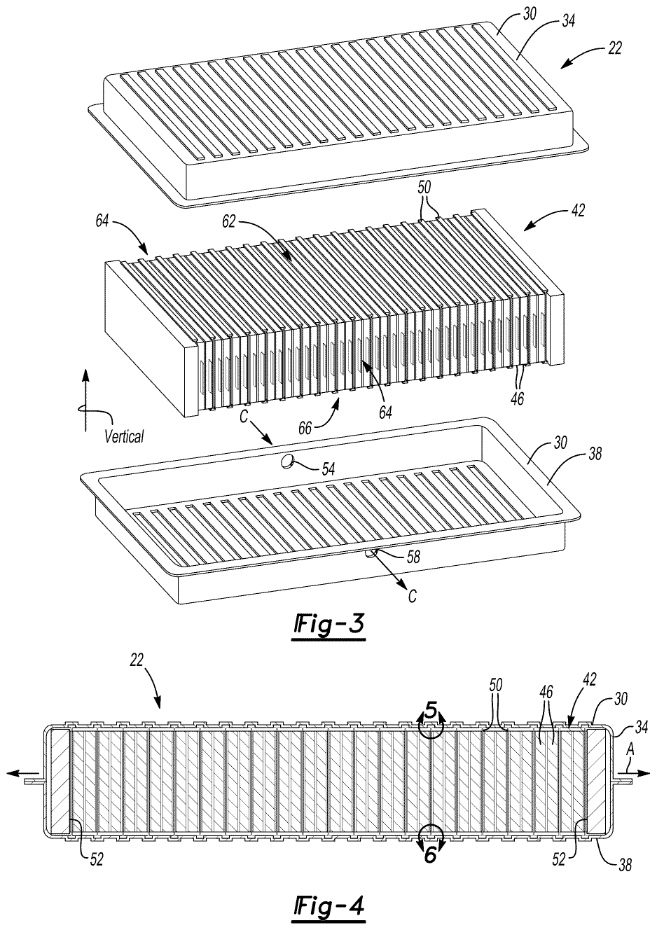

The cell stack 42 could include any number of battery cells 46. The battery array 22 could be expanded to employ multiple cell stacks 42 within the enclosure assembly 30. Thus, this disclosure is not limited to the exact configuration shown in FIG. 2. Further, while the battery cells 46 and support assemblies 50 of FIG. 3 are positioned side-by-side relative to one another, other configurations are also contemplated within the scope of this disclosure, including but not limited to embodiments in which the battery cells 46 and support assemblies 50 are stacked on top of one another, for example.

In the exemplary embodiment, the battery cells 46 are pouch-style, lithium-ion cells. However, battery cells having other geometries (cylindrical, prismatic, etc.), other chemistries (nickel-metal hydride, lead-acid, etc.), or both could alternatively be utilized within the scope of this disclosure.

The cell stack 42 is arranged in the interior of the enclosure assembly 30 between the tray 38 and the cover 34. A thermal management system is used to manage thermal energy levels within the battery array 22. The example thermal management system is configured to route non-conductive (i.e., dielectric) coolant C into the interior of the enclosure assembly 30 and over areas of the cell stack 42 to manage thermal energy within the cell stack 42 by, for example, using the coolant C to take on heat from the cell stack 42. The thermal management system is an immersion thermal management system at least because portions of the battery array 22, here at least the battery cells 46 of the cell stack 42 are immersed in the coolant C.

In this example, the coolant C generally flows from an inlet 54, which is formed near a vertical bottom of the enclosure assembly 30 on a side of the cell stack 42, to an outlet 58, which is on an opposite side of the cell stack 42. The cell stack 42 has a top side 62, opposing outboard sides 64, and a bottom side 66.

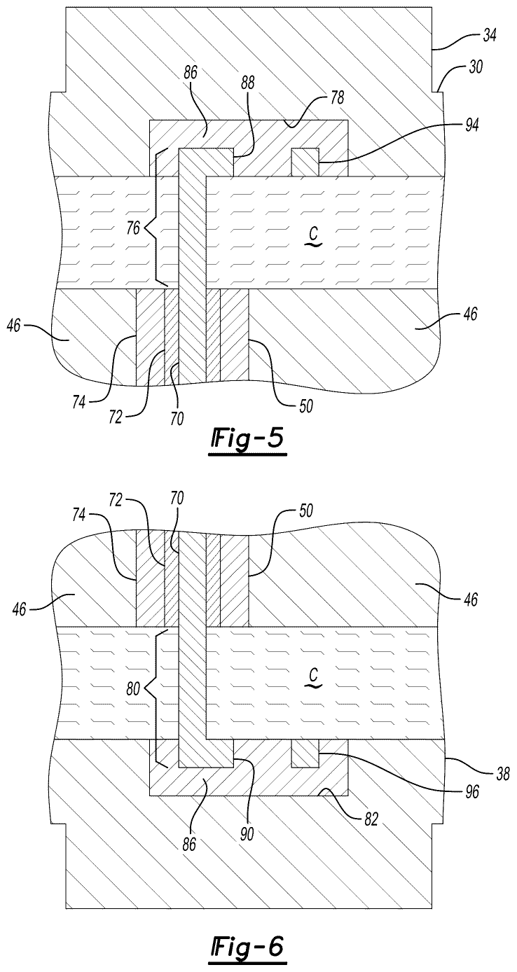

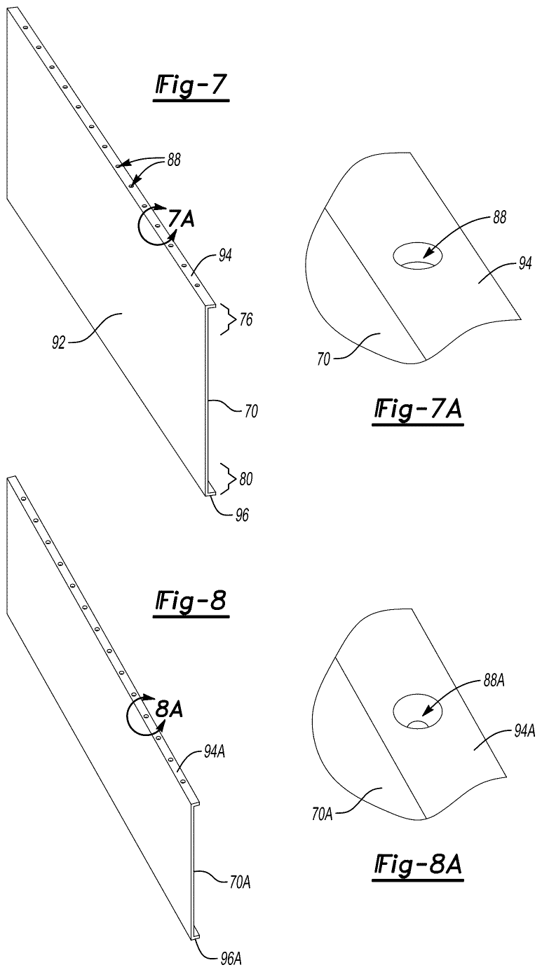

With reference now to FIGS. 5-7A and continuing reference to FIGS. 2-4, some of the coolant C communicates within the interior of the enclosure assembly 30 over a vertical top of the cell stack 42 as shown in FIG. 5. Some of the coolant C communicates beneath the cell stack 42 as shown in FIG. 6. Thermal energy can transfer back-and-forth between the coolant C and the battery cells 46 and between the coolant C and other components as the coolant C moves through the interior of the enclosure assembly 30.

The coolant C can be a dielectric liquid coolant. The coolant C can be used to cool the battery cells 46 and other components. In some examples, the coolant C can be used to heat the battery cells 46 and other components.

The example support assemblies 50 each include a support fin 70 sandwiched between layers of a thermal barrier 72 and layers of foam 74. In this example, the support fins 70 each have a C-shaped cross-sectional profile. The support fins 70 can support weight of the cell stack 42 in a position spaced vertically upward from the enclosure tray 38 and spaced vertically downward from the enclosure cover 34 to locate the cell stack 42 within the enclosure 30. The support fins 70 can be considered thermal fins. The support fins 70 can be a metal or metal alloy.

The support fin 70 includes a first peripheral portion 76 that projects vertically upward past the battery cells 46 and is at least partially received within a groove 78 of the enclosure cover 34. The support fin 70 includes a second peripheral portion 80 that projects vertically downward beneath the battery cells 46 and is at least partially received within a groove 82 of the enclosure tray 38.

Adhesive 86 is utilized to bond the first peripheral portion 76 to the enclosure cover 34, and to bond the second peripheral 80 to the enclosure tray 38. During assembly, the adhesive 86 can be deposited within the respective grooves 78 and 82 of the enclosure assembly 30. Prior to the adhesive 86 curing, the first peripheral portion 76 is moved into the adhesive 86 within the groove 78 and the second peripheral portion 80 is moved at least partially into the groove 82. The adhesive 86 can then cure to bond the first peripheral portion 76 to the enclosure cover 34 and the second peripheral portion 80 to the enclosure tray 38.

Notably, the first peripheral portion 76 includes a plurality of apertures 88 or perforations. The second peripheral portion 80 includes a plurality of apertures 90 or perforations. As the first peripheral portion 76 is moved into the groove 78, some of the adhesive 86 moves into the apertures 88. Similarly, as the second peripheral portion 80 is moved into the groove 82, adhesive 86 moves into the apertures 90.

The adhesive 86 is held within the apertures 88 and 90 and cures. The adhesive 86 that extends through the apertures 88 and 90 facilitates bonding the support fin 70 to the enclosure assembly 30. Due to the adhesive 86 extending into the apertures 88 and 90, more adhesive 86, when cured, carries additional shear loads. The filling of the apertures 88 and 90 with the adhesive 86 increases the contact area between the adhesive 86 and the support fin 70.

In the exemplary embodiment, the support fin 70 includes a divider section 92, a first flange 94 at a first end of the divider section 92, and a second flange 96 at an opposite, second end of the divider section 92. The divider section 92 is the portion of the exemplary support fin 70 that extends vertically and passes between the battery cells 46 of the cell stack 42. Adhesive can be used to bond the divider section 92 of the support fin 70 to the layers thermal barrier 72, the layers of foam 74, the cells 46, or some combination of these.

The first flange 94 and the second flange 96 extend transversely from opposing ends of the divider section 92 to provide the support fin 70 with the C-shape cross-sectional profile.

The first peripheral portion 76 includes some of the divider section 92 and the first flange 94. The second peripheral portion 80 includes some of the divider section 92 and the second flange 96. In this example, the first flange 94 extends at a 90-degree angle from the divider section 92. Similarly, the second flange 96 extends at a 90-degree angle away from the divider section 92. Angles other than 90-degrees are possible and could be utilized in other examples. In the exemplary embodiment, the first flange 94 and the second flange 96 each extend in a direction parallel to the cell stack axis A.

The apertures 88 of the first peripheral portion 76 are disposed within the first flange 94 and extend completely through the first flange 94. The apertures 88 extend from the first side of the first peripheral portion 76 that faces outward away from the cell stack 42 to an opposite second side that faces inward toward the cell stack 42. Similarly, the apertures 90 in the second peripheral portion 80 are located within the second flange 96 and extend completely through the second flange 96.

The apertures 88 and 90 are cylindrical bores in the exemplary embodiment. The apertures 88 and 90 extend along respective axes that are perpendicular to the cell stack axis A. In other examples, the apertures 88 do not extend completely through the first flange 94, and the apertures 90 do not extend completely through the second flange 96. Such apertures could be dimples, for example.

Other types of apertures are possible and could be utilized in other examples. For example, with reference to FIGS. 8 and 8A, a support fin 70A according to another exemplary embodiment of the present disclosure includes apertures 88A within a flange 94A. The apertures 88A are tapered bores. Similar tapered bores could be provided within a second flange 96A of the support fin 70A.

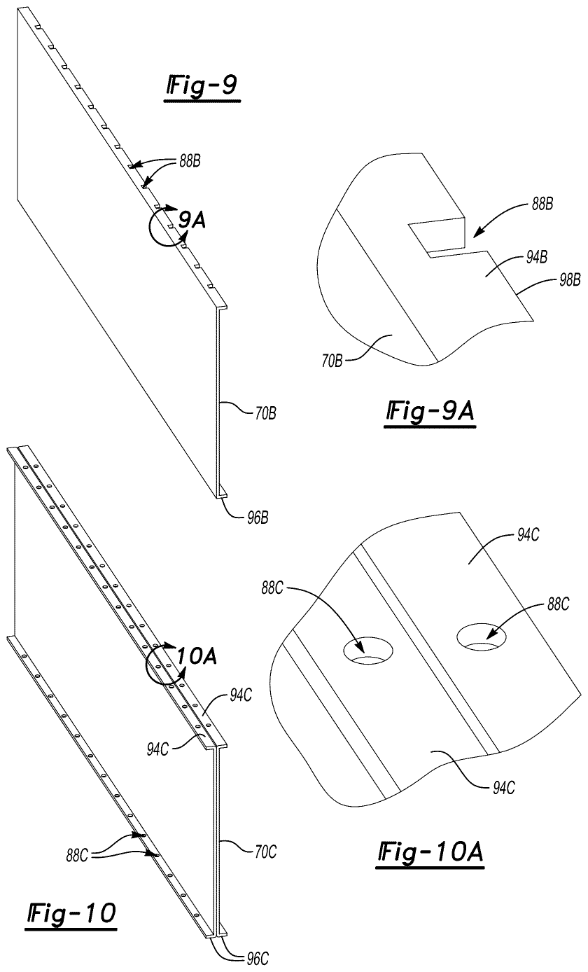

With reference to FIGS. 9 and 9A, a fin 70B according to another exemplary aspect of the present disclosure, includes apertures 88B within an attachment flange 94B. The apertures 88B are open slots that open to an endface 98B of the attachment flange 94B of the support fin 70B. Similar apertures 88B that are open slots could be incorporated into a flange 96B at a vertical bottom of the support fin 70B.

With reference now to FIGS. 10 and 10A, yet another example support fin 70C is a fin assembly comprising two individual C-shaped fins positioned back-to-back to provide an I-shaped support fin assembly. First attachment flanges 94C of the support fins 70C include cylindrical bores 88C. Second attachment flanges 96C could similarly include cylindrical bores 88C.

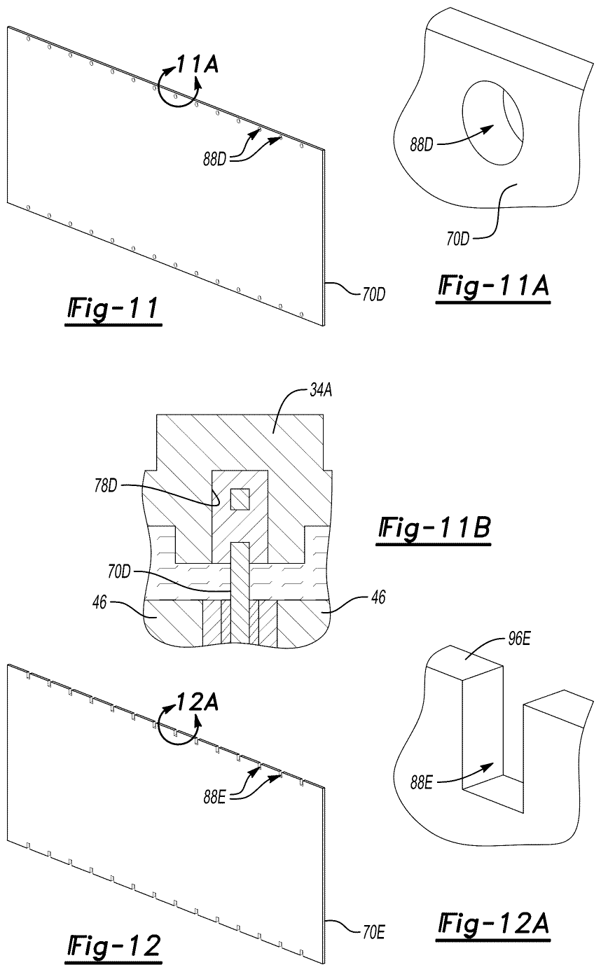

With reference now to FIGS. 11, 11A, and 11B, yet another example support fin 70D includes apertures 88D, which are cylindrical bores extending through a vertically extending portion of the support fin 70D. The example support fin 70D does not include flanges extending transversely from another portion of the support fin 70D. The vertically uppermost region and vertically lowermost region of the support fin 70D provides the respective first and second flanges that are fit within a groove 78D within an enclosure cover 34D. The second flange of the support fin 70D can be received within a corresponding groove within an enclosure tray.

With reference now to FIGS. 12 and 12A, yet another example support fin 70E is styled similarly to the support fin 70D of FIGS. 11-11B, however, the support fin 70E includes apertures 88E that are open slots opening to respective endfaces 96E of the support fin 70E.

Features of the disclosed examples include fins having apertures that receive adhesive to to facilitate bonding the fins to an enclosure assembly. The support assemblies having the fins can support a weight of a cell stack in an elevated position within an enclosure assembly of a traction battery pack. A coolant can move above and beneath the stack within the enclosure assembly.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A battery pack assembly, comprising:
an enclosure assembly;
a support assembly of a cell stack, the support assembly having a peripheral portion that is at least partially received within a groove of the enclosure assembly, the peripheral portion having one or more apertures; and
an adhesive bonding the peripheral portion to the enclosure assembly, the adhesive extending through the one or more apertures.

2. The battery pack assembly of claim 1, wherein the peripheral portion is a first peripheral portion of the support assembly on a first side of the cell stack, the support assembly further including a second peripheral portion on an opposite second side of the cell stack, wherein the groove is a first groove within an enclosure cover of the enclosure assembly, the second peripheral portion of the support assembly received within a second groove of the enclosure assembly, the second groove within an enclosure tray of the enclosure assembly.

3. The battery pack assembly of claim 2, wherein the first peripheral portion extends vertically upward from the cell stack, and the second peripheral portion extends vertically downward from the cell stack.

4. The battery pack assembly of claim 1, wherein the support assembly has a C-shaped cross-sectional profile.

5. The battery pack assembly of claim 1, wherein the cell stack includes a plurality of battery cells disposed along an axis, the support assembly having a divider section that extends between battery, and a flange extending transversely from the divider section, wherein the flange and the at least one aperture are within the peripheral portion.

6. The battery pack assembly of claim 5, wherein the one or more apertures each extend completely through the flange, from a first side of the flange to an opposite, second side of the flange.

7. The battery pack assembly of claim 6, wherein the first side of the flange faces outward away from the cell stack, and the second side of the flange faces inward toward the cell stack.

8. The battery pack assembly of claim 7, wherein the one or more apertures are one or more tapered bore.

9. The battery pack assembly of claim 7, wherein the one or more apertures each extend along a respective aperture axis that is transverse to an axis of the cell stack.

10. The battery pack assembly of claim 1, wherein the one or more apertures each extend along a respective aperture axis that is transverse to an axis of the cell stack.

11. The battery pack assembly of claim 1, wherein the cell stack is at least partially immersed in a dielectric liquid coolant.

12. The battery pack assembly of claim 1, wherein the support assembly supports the cell stack within the enclosure assembly at a position where battery cells of the cell stack are spaced from an enclosure tray of the enclosure assembly and are spaced from an enclosure cover of the enclosure assembly.

13. The battery pack assembly of claim 1, wherein the support assembly is a metal or a metal alloy.

14. The battery pack assembly of claim 1, wherein the one or more apertures are one or more open slots that each open to an endface of the peripheral portion.

15. The battery pack assembly of claim 1, wherein the one or more apertures are one or more cylindrical bores.

16. The battery pack assembly of claim 1, wherein the one or more apertures each extend completely through the support assembly.

17. A battery pack assembly, comprising:
an enclosure assembly holding a dielectric immersion coolant;
at least one first battery cell of a cell stack;
at least one second battery cell of the cell stack; and
a support assembly that supports the cell stack within an enclosure assembly, the support assembly disposed axially between the at least one first battery cell and the at least one second battery cell, the support assembly having a first peripheral portion bonded to a first groove of the enclosure assembly on a first side of the cell stack, and a second peripheral portion bonded to a second groove of the enclosure assembly on an opposite, second side of the cell stack, the first and second peripheral portions each having one or more apertures that hold an adhesive.

18. The battery pack assembly of claim 17, further comprising an enclosure cover and an enclosure tray of the enclosure assembly, the enclosure cover providing the first groove, the enclosure tray providing the second groove.

19. The battery pack assembly of claim 17, wherein the one or more apertures in the first peripheral portion comprises one or more first open slots that each open to a first endface of the first peripheral portion, wherein the one or more apertures in the second peripheral portion comprise one or more second open slots that each open to a second endface of the second peripheral portion.

20. The battery pack assembly of claim 17, wherein the one or more apertures each extend completely through the support assembly.
